(19) United States
(12) Patent Application Publication
(10) Pub. No.: US 2006/0228499 A1
(43) Pub. Date: Oct. 12, 2006

(54) Printing media with polydicyandiamides and multi-valent salts

(76) Inventors: Hai Q. Tran, San Diego, CA (US); Richard Anderson, Escondido, CA (US); Yi-Hua Tsao, San Diego, CA (US); Christian Schmid, Rancho Bernardo, CA (US); John L. Stoffel, San Diego, CA (US); William R. Sperry, San Diego, CA (US)

Correspondence Address: HEWLETT-PACKARD COMPANY;Intellectual Property Administration, P.O. Box 272400, Fort Collins, CO, 80527-2400, US

(21) Appl. No.: 11/103,827

(22) Filed: Apr. 11, 2005

(51) Int. Cl. B41M 5/00

(52) U.S. Cl. 428/32.21

(57) ABSTRACT

The present invention is drawn to a media sheets, including paper media sheets, which are effective for use in improving water fastness of inks, such as ink-jet inks. The media sheet can comprise a paper substrate, and a polydicyandiamide and a multivalent salt associated with the paper substrate. The polydicyandiamide and the multivalent salt are associated with the paper substrate prior to the ink-jet application.

### FIELD OF THE INVENTION

The present invention relates generally to printing media. More particularly, the present invention relates to water fast media for use in ink-jet printing applications.

### BACKGROUND OF THE INVENTION

Ink-jet and electrophotographic printing is becoming popular for in-house publishing and other applications. To achieve a high quality image, printing media selected for use can play an important role. In particular, with respect to ink-jet printing on plain paper media, printed inks are often not very water fast. For example, when water or other liquids are inadvertently dripped onto ink-jet printed media, often the pigments or dyes of the ink-jet ink do not maintain acceptable permanence on the media. Further, even when printing on media, such as plain paper, as intended, i.e., with aqueous ink-jet ink and/or fixer, the aqueous composition(s) tend to wet the fibers of the paper such that certain undesirable results occur. For example, after wetting and subsequent drying, cellulose fiber-to-fiber associations, or H-bonds, can be disrupted, resulting in curl or cockle.

As a result, there is a need to develop print media, such as plain paper type print media, that provides images that are more water fast, and at the same time, have acceptable print characteristics when used as intended.

### SUMMARY OF THE INVENTION

It has been recognized that it would be advantageous to develop a media sheet that is effective for use with various types of ink-jet applications. The media sheet for ink-jet application can comprise a paper substrate, and a polydicyandiamide and a multivalent salt associated with the paper substrate. The polydicyandiamide and the multivalent salt can be associated with the paper substrate prior to the ink-jet application.

In another embodiment, a method of preparing a media sheet for ink-jet application can comprise preparing a paper substrate, and associating a polydicyandiamide and a multivalent salt with the paper substrate. The polydicyandiamide and the multivalent salt can be associated with the paper substrate prior to the ink-jet application.

Additional features and advantages of the invention will be apparent from the detailed description which illustrates, by way of example, features of the invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular form of “a,” “an,” and “the” include plural referents unless the context clearly dictates otherwise. Thus, for example, reference to “a binder” includes reference to one or more of such materials.

The term “paper,” “paper substrate,” or “base stock” includes traditional papers such as woody paper, synthetic paper, and regenerated paper. More generally, this term is meant to encompass a substrate based on cellulosic fibers and other known paper fibers. The substrate may be of any dimension, e.g., size or thickness, or form, e.g., pulp, wet paper, dry paper, etc. The substrate is preferably in the form of a flat or sheet structure, which may be of variable dimensions. In particular, substrate is meant to encompass plain paper, writing paper, drawing paper, photobase paper, and the like. The paper substrate can be from about 2 mils to about 30 mils thick, depending on a desired end application for the print medium.

The term “coating layer(s)” refers to coating compositions which can be applied as a coating layer for application to a paper substrate. Often, the coating layer is in the form of a surface sizing composition that is applied to the paper. These layers can include polydicyandiamides and/or multivalent salts, but can optionally include any of a group of other compounds, such as inorganic pigments, binder, starch, optical brighteners, or the like.

“Inorganic pigments” include particulates that can be in a powder or slurry form, and include such materials as titanium dioxide, hydrated alumina, calcium carbonate, barium sulfate, silica, clay, and zinc oxide. Other inorganic pigments can be used as would be known to one skilled in the art after considering the present disclosure.

“Binder” refers to compositions that can be used to enhance the adhesion within a base coating layer, and optionally, can provide adhesion within the receiving layer. Binder can also provide adhesion between media layers. Typically, the binder can be a water soluble polymer or water dispersible polymeric latex.

Temperature, ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

The term “about” when referring to a numerical value or range is intended to encompass the values resulting from experimental error that can occur when taking measurements.

With these definitions in mind, a media sheet for ink-jet application can comprise a paper substrate, and a polydicyandiamide and a multivalent salt associated with the paper substrate. The polydicyandiamide and the multivalent salt can be associated with the paper substrate prior the ink-jet application. In another embodiment, a method of preparing a media sheet for ink-jet application can comprise preparing a paper substrate, and associating a polydicyandiamide and a multivalent salt with the paper substrate. The polydicyandiamide and the multivalent salt can be associated with said paper substrate prior said ink-jet application.

In either embodiment, the polydicyandiamide and the multivalent salt can be i) coated on a surface of the paper substrate; ii) incorporated within the paper substrate; iii) coated on a surface of the paper substrate and incorporated within the paper substrate; or iv) any other combination where one or more of the polydicyandiamide and the multivalent salt is coated on a surface of the paper substrate or one or more of the polydicyandiamide and the multivalent salt is incorporated within the paper substrate.

As discussed above, and provided in greater detail herein, the paper media of the present invention can include polydicyandiamides and/or multivalent salts applied in number different ways. For example, both the polydicyandiamides and the multivalent salts can be incorporated into the paper making process per se such that the paper includes both of these compounds within the interstitial spaces of the paper fibers. Alternatively, both the polydicyandiamides and the multivalent salts can be incorporated onto a surface of the paper as a coating, such as with a sizing composition. In still another embodiment, one of the polydicyandiamide and the multivalent salt can be incorporated into the paper making process per se, and the other can be applied as a coating. Still further, both can be present within the paper, and one can be applied to the surface; or one can be present within the paper, and both can be present on the surface. Even further, both compounds can be applied within the paper and applied to the paper surface.

Whether the polydicyandiamides and/or multivalent salts are applied as a coating and/or incorporated within the paper substrate, any of various types of paper substrates can be used, including woody papers, synthetic papers, recycled papers, etc. Fabric papers can also be used, such as those prepared using Northern or Southern softwood and hardwood, and other various pulps. These paper pulps can include chemical pulp, such as hardwood bleached Kraft pulp, softwood bleached Kraft pulp, softwood bleached sulfite pulp, stone groundwood, and/or refiner pulp. Non-wood pulp such as cotton pulp, recycled wastepaper pulp, or the like, can also be used for making the paper substrate or base stock.

Aside from these major components described above, a small amount of additive can also be present within the paper or within a coating composition, e.g., sizing composition, to be applied to the paper. Such additives include inorganic pigments, binders, starches, optical brighteners, dyes to control paper color, lubricants, surfactants, rheological modifiers, cross-linkers (such as for water proofing), deformers, and/or dispersing agents, to name a few examples.

Though a requirement for the whiteness or brightness of the paper substrate or base stock is not critical, very white paper stock can be used. Additionally, filling and sizing processing of papers that is known in the art can be used to control paper density, stiffness, and/or surface properties. In one embodiment, if present, the ash content of the paper substrate, i.e. the percentage of inorganic material incorporated inside the paper including inorganic fillers and pigment material derived from a recycled fiber component of the substrate, can be from about 8 wt % to 20 wt %.

A general paper making process is described herein, but it should be emphasized that other paper making processes can be used in accordance with embodiments of the present invention. Generally, a stock material, such as wood stock, is converted to a fibrous material or fibrous pulp by the addition of water and any other types of additives or solvents known in the art. The addition of water and/or other additives or solvents can create an emulsion of the fibrous pulp, which is easier to handle. Next, the fibrous component is flattened to a preset thickness. It should be noted that non-wood fibrous pulp can also be used to produce the print media, and the use of wood stock is merely illustrative.

Typical paper making machines or systems include a dryer, a surface sizing system, and a calendaring system. The dryer facilitates in evaporating the water and other volatiles from the fibrous component. At the surface size press, additional surface sizing composition, e.g., starch, optical brighteners, and the like, can be added to the surface of the paper to achieve a final feel/texture and visual appeal of the print medium. Generally, the surface sizing compound is an aqueous solution that is coated onto the paper. A calendaring tool is also often used to flatten the print medium to its final thickness, as well as smooth the print medium. The polydicyandiamides and/or multivalent salts can be added to the pulp while forming the paper, and/or can be added to the surface size press so that it can be applied as a coating to the paper. In either case, as water and other volatiles are evaporated off, the polydicyandiamides and/or multivalent salts remain disposed on or within the fibers of the paper.

As noted, the polydicyandiamides and/or multivalent salts can be introduced to the fibrous component at one or more steps of the print medium making process, e.g., during draw down/coating or incorporated into bulk slurry. If included in the bulk slurry of the fibrous pulp during the process of making the paper, these compositions become disposed within and among the paper fibers and become an integral part of the substrate. If applied as a coating, then to a lesser extent, the polydicyandiamides and/or multivalent salts can become integrated within the fibers. In other words, by incorporating the polydicyandiamides and/or multivalent salts within the paper at the pulp stage, these additives can be evenly distributed throughout the paper. If applied as a coating, there will likely be a greater concentration of these additives at or near the surface of the paper.

In accordance with embodiments of the present invention, polydicyandiamides can be loaded within the paper, i.e. added to the pulp, assuming papers within a standard range of thicknesses at a concentration form about 0.1 gsm to about 25 gsm. Likewise, the multivalent salts can be loaded within the paper at from 0.1 gsm to about 25 gsm. When coated on the paper, such as with a surface sizing composition, the polydicyandiamides can be loaded in the surface sizing composition at a concentration form about 0.1 gsm to about 25 gsm. Likewise, the multivalent salts can be loaded within the surface sizing composition at from 0.1 gsm to about 25 gsm.

When determining which polydicyandiamide compounds to add, the following list is inclusive of preferred examples. The polydicyandiamides that can be used include, but is not limited to, dicyandiamide-polyalkylenepolyamine condensates, polyalkylenepolyamine-dicyandiamideammonium condensates, dicyandiamide-formalin condensates, or the like.

In one embodiment, polydicyandiamide resins can be used, and can be prepared by condensation of dicyandiamide with formaldehyde, followed by quaternization with ammonium chloride, as shown in Formulas 1a and 1b below: 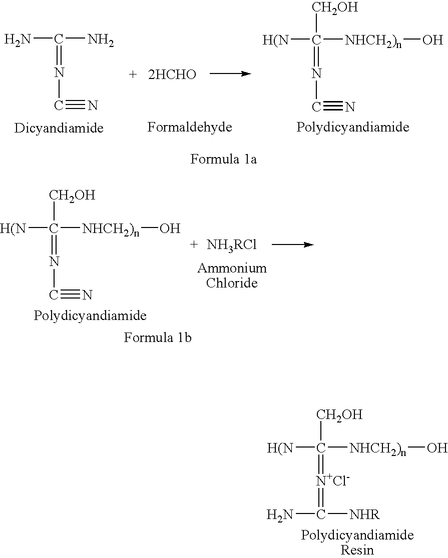
where R is H or an unsubstituted or substituted C₁-C₈ alkyl, and n is from 10 to 1,000,000.

Regarding the multivalent metallic salts, metallic salts that can be used include but not limited to, Group II metals (alkaline earth metals), Group III metals (lanthanides), and multivalent transition metals. In particular, the metallic cations that can be produced using these salts include, but are not limited to, calcium, magnesium, copper, nickel, zinc, barium, iron, aluminum, chromium, or the like. The anionic species of the salt can be chloride, iodide, bromide, nitrate, sulfate, sulfite, phosphate, chlorate, acetate, benzoate, methane sulfonate, and toluene sulfonate, or the like. In one embodiment, calcium chloride is a preferred multivalent metal salt that can be used in accordance with embodiments of the present invention.

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the most practical and preferred embodiments of the invention.

### Example 1

Black Optical Density

A solution of 5 wt % CaCl₂ and 5 wt % of a polydicyandiamide is incorporated into a plain paper formulation at approximately a 1.5 gsm (plain paper with additives). A plain paper prepared in accordance with the same specifications without the above-mentioned additives was also prepared for comparison purposes (plain paper without additives). Three different ink systems were used to prepare printed images including black printed images on both the plain paper with additives and the plain paper without additives. The optical density of each black image was recorded, and the results are provided graphically in FIG. 1. The optical density measurements were carried out using a densitometer to measure the blackness of area fills. The higher value of optical density indicates that the prints show darker blacks.

### Example 2

Color Gamut

A solution of 5 wt % CaCl₂ and 5 wt % of a polydicyandiamide is incorporated into a plain paper formulation at approximately a 1.5 gsm (plain paper with additives). A plain paper prepared in accordance with the same specifications without the above-mentioned additives was also prepared for comparison purposes (plain paper without additives). Three different ink systems were used to prepare printed images including color printed images on both the plain paper with additives and the plain paper without additives. The color gamut of each printed image was recorded, and the results are provided graphically in FIG. 2. The color gamut measurements were carried out on squares of primary color (cyan, magenta, and yellow) and secondary colors (red, green, and blue). An L*a*b* value is obtain from the measurement, where the higher value of color gamut indicates that the prints show richer or more saturated colors.

### Example 3

Drip Fastness

A solution of 5 wt % CaCl₂ and 5 wt % of a polydicyandiamide is incorporated into a plain paper formulation at approximately a 1.5 gsm (plain paper with additives). A plain paper prepared in accordance with the same specifications without the above-mentioned additives was also prepared for comparison purposes (plain paper without additives). Three different ink systems were used to prepare printed images including black and color printed images on both the plain paper with additives and the plain paper without additives. Drip fastness testing was carried out by printing bars and dropping 50 uL units of water onto the printed sample and allowing the the water to run off in the form of a drip. Measurements of optical density were carried out in the drip zone to see how much ink migrated from bar. In this test, a lower optical density indicates better drip fastness, as less color has migrated from the printed bar

As can be seen from Example 1-3 above, optical density, color gamut, and drip fastness is improved when printed on papers prepared in accordance with embodiments of the present invention compared to when the same inks are printed on plain paper.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. A media sheet for ink-jet application, comprising:
a paper substrate; and
a polydicyandiamide and a multivalent salt associated with said paper substrate, said polydicyandiamide and said multivalent salt being associated with said paper substrate prior to said ink-jet application.

2. A media sheet as in claim 1, wherein the polydicyandiamide and the multivalent salt are coated on a surface of the paper substrate.

3. A media sheet as in claim 1, wherein the polydicyandiamide and the multivalent salt are incorporated within the paper substrate.

4. A media sheet as in claim 1, wherein the polydicyandiamide and the multivalent salt are coated on a surface of the paper substrate and incorporated within the paper substrate.

5. A media sheet as in claim 1, wherein the polydicyandiamide is coated on a surface of the paper substrate and the multivalent salt is incorporated within the paper substrate.

6. A media sheet as in claim 1, wherein the multivalent salt is coated on a surface of the paper substrate and the polydicyandiamide is incorporated within the paper substrate.

7. A media sheet as in claim 1, wherein at least one of the polydicyandiamide and the multivalent salt is coated on a surface of the paper substrate in a coating composition, said coating composition further including an additive selected from the group consisting of inorganic pigments, binders, starches, optical brighteners, dyes, lubricants, surfactants, rheological modifiers, cross-linkers, deformers, dispersing agents, and combinations thereof.

8. A media sheet as in claim 1, wherein at least one of the polydicyandiamide and the multivalent salt is incorporated within the paper substrate, said paper substrate including paper fibers and an additive selected from the group consisting of inorganic pigments, binders, starches, optical brighteners, dyes, lubricants, surfactants, rheological modifiers, cross-linkers, deformers, dispersing agents, and combinations thereof.

9. A media sheet as in claim 1, wherein the paper substrate is selected from the group consisting of woody paper, synthetic paper, recycled paper, and fabric papers.

10. A media sheet as in claim 1, wherein the polydicyandiamide is selected form the group consisting of dicyandiamide-polyalkylenepolyamine condensates, polyalkylenepolyamine-dicyandiamideammonium condensates, and dicyandiamide-formalin condensates.

11. A media sheet as in claim 1, wherein the polydicyandiamide is a quaternary polydicyandiamide resin.

12. A media sheet as in claim 1, wherein the multivalent salt includes a metal selected from the group consisting of calcium, magnesium, copper, nickel, zinc, barium, iron, aluminum, and chromium.

13. A media sheet as in claim 1, wherein the multivalent salt includes an anionic species selected form the group consisting of chloride, iodide, bromide, nitrate, sulfate, sulfite, phosphate, chlorate, acetate, benzoate, methane sulfonate, and toluene sulfonate.

14. A media sheet as in claim 1, wherein the multivalent salt is an alkaline earth metal salt.

15. A media sheet as in claim 14, wherein the alkaline earth metal salt is a calcium salt.

16. A media sheet as in claim 15, wherein the calcium salt is calcium chloride.

17. A media sheet as in claim 1, wherein the multivalent salt is a transition metal salt.

18. A method of preparing a media sheet for ink-jet application, comprising:
preparing a paper substrate; and
associating a polydicyandiamide and a multivalent salt with the paper substrate, said polydicyandiamide and said multivalent salt being associated with said paper substrate prior to said ink-jet application.

19. A method as in claim 18, wherein the step of associating includes coating the polydicyandiamide and the multivalent salt on a surface of the paper substrate.

20. A method as in claim 18, wherein the step of associating includes incorporating the polydicyandiamide and the multivalent salt within the paper substrate.

21. A method as in claim 18, wherein the step of associating includes incorporating the polydicyandiamide and the multivalent salt within the paper substrate, and further includes coating the polydicyandiamide and the multivalent salt on a surface of the paper substrate.

22. A method as in claim 18, wherein the step of associating includes incorporating the multivalent salt within the paper substrate, and further includes coating the polydicyandiamide on a surface of the paper substrate.

23. A method as in claim 18, wherein the step of associating includes incorporating the polydicyandiamide within the paper substrate, and further includes coating the multivalent salt on a surface of the paper substrate.

24. A method as in claim 18, wherein the step of associating includes coating at least one of the polydicyandiamide and the multivalent salt on a surface of the paper substrate in a coating composition, said coating composition further including an additive selected from the group consisting of inorganic pigments, binders, starches, optical brighteners, dyes, lubricants, surfactants, rheological modifiers, cross-linkers, deformers, dispersing agents, and combinations thereof.

25. A method as in claim 18, wherein the step of associating includes incorporating at least one of the polydicyandiamide and the multivalent salt within the paper substrate, said paper substrate including paper fibers and an additive selected from the group consisting of inorganic pigments, binders, starches, optical brighteners, dyes, lubricants, surfactants, rheological modifiers, cross-linkers, deformers, dispersing agents, and combinations thereof.

26. A method as in claim 18, wherein the paper substrate is selected from the group consisting of woody paper, synthetic paper, recycled paper, and fabric papers.

27. A method as in claim 18, wherein the polydicyandiamide is selected form the group consisting of dicyandiamide-polyalkylenepolyamine condensates, polyalkylenepolyamine-dicyandiamideammonium condensates, and dicyandiamide-formalin condensates.

28. A method as in claim 18, wherein the polydicyandiamide is a quaternary polydicyandiamide resin.

29. A method as in claim 18, wherein the multivalent salt includes a metal selected from the group consisting of calcium, magnesium, copper, nickel, zinc, barium, iron, aluminum, and chromium.

30. A method as in claim 18, wherein the multivalent salt includes an anionic species selected form the group consisting of chloride, iodide, bromide, nitrate, sulfate, sulfite, phosphate, chlorate, acetate, benzoate, methane sulfonate, and toluene sulfonate.

31. A method as in claim 18, wherein the multivalent salt is an alkaline earth metal salt.

32. A method as in claim 31, wherein the alkaline earth metal salt is a calcium salt.

33. A method as in claim 32, wherein the calcium salt is calcium chloride.

34. A method as in claim 18, wherein the multivalent salt is a transition metal salt.
